(19) United States
(12) Patent Application Publication
(10) Pub. No.: US 2021/0130963 A1
(43) Pub. Date: May 6, 2021

(54) COATED CARBON FIBER REINFORCED POLYMERIC COMPOSITES FOR CORROSION PROTECTION

(71) Applicant: GM GLOBAL TECHNOLOGY OPERATIONS LLC, Detroit, MI (US)

(72) Inventors: Selina X. ZHAO, Rochester Hills, MI (US); Hongliang WANG, Sterling Heights, MI (US); William R. RODGERS, Bloomfield Township, MI (US)

(73) Assignee: GM GLOBAL TECHNOLOGY OPERATIONS LLC, Detroit, MI (US)

(21) Appl. No.: 16/675,801

(22) Filed: Nov. 6, 2019

(51) Int. Cl. C23F 13/12

(52) U.S. Cl. CPC C23F 13/12; C23F 2213/30

(57) ABSTRACT

An assembly for a vehicle having reduced galvanic corrosion includes a first component defining at least one interface region that includes a carbon-fiber reinforced polymeric composite (CFRP) and a first material present in the at least one interface region and having a first electrochemical potential. A second component has a second material and is in contact with the at least one interface region of the first component. The second material has a second electrochemical potential different than the first electrochemical potential. In this manner, in the presence of an electrolyte the first material may be either less noble than the second material and serve as a sacrificial material or alternatively more noble to the second material reducing a driving force for corrosion. Methods of reducing galvanic corrosion in an assembly (e.g., for a vehicle) are also provided.

### INTRODUCTION

This section provides background information related to the present disclosure which is not necessarily prior art.

The present disclosure pertains to an assembly for a vehicle having carbon-fiber reinforced polymeric composite components and reduced galvanic corrosion and methods of reducing galvanic corrosion in such assemblies for a vehicle.

Galvanic protection in vehicle components formed of dissimilar materials in contact or proximity with one another (e.g., different metal materials or metal/composite materials) can pose various challenges. Such components may be used in vehicles like automobiles, snowmobiles, motorcycles, and the like. Where the dissimilar materials having distinct electrochemical potentials intermittently encounter an electrolyte, corrosion may occur in the material having a lower electrochemical potential or less noble material.

Polymeric composite materials, like carbon fiber reinforced plastics (CFRP), are generally considered to be galvanically incompatible with metal materials. Carbon, especially in a graphite form, serves as an efficient cathode. Thus, in the past, galvanic protection has focused on completely isolating the carbon containing material from nearby metals. However, use of coatings and other isolation techniques in dissimilar materials that employ carbon fiber composites can potentially still be vulnerable to galvanic corrosion over time, especially in non-marine environments where galvanic corrosion is intermittent and localized. Furthermore, even if a corrosion protection coating has no weak or vulnerable regions whatsoever, fastening the dissimilar materials together (e.g., via mechanical fasteners, welding, or adhesives) disturbs the corrosion protection coatings and provides potential corrosion pathways. Thus, additional techniques for galvanic protection of assemblies of components employing dissimilar materials, including carbon fiber containing composites with metals, would be highly desirable to improve reliability and reduce potential corrosion of such parts in vehicles.

### SUMMARY

This section provides a general summary of the disclosure, and is not a comprehensive disclosure of its full scope or all of its features.

The present disclosure relates to an assembly for a vehicle having reduced galvanic corrosion. In certain variations, the assembly includes a first component defining at least one interface region and including a polymeric composite including a polymer and a plurality of carbon fibers and a first material present in the at least one interface region and having a first electrochemical potential. A second component includes a second material in contact with the at least one interface region of the first component. The second material has a second electrochemical potential different than the first electrochemical potential.

In certain aspects, the first electrochemical potential is higher than the second electrochemical potential. In certain aspects, in the presence of an electrolyte, the second material is less noble than the first material.

In one further aspect, (i) the first material includes copper and the second material includes steel, (ii) the first material includes titanium and the second material includes stainless steel; or (iii) the first material includes mild steel and the second material includes aluminum.

In certain aspects, the second electrochemical potential is higher than the first electrochemical potential, so that in the presence of an electrolyte the first material is less noble than the second material.

In one further aspect, (i) the first material includes copper and the second material includes stainless steel; (ii) the first material includes zinc and the second material includes aluminum; or (iii) the first material includes aluminum and the second material includes steel.

In certain aspects, each carbon fiber present in the interface region has a coating including the first material. The coating has a thickness of greater than or equal to about 100 nm to less than or equal to about 10 micrometers.

In certain aspects, the polymeric composite includes a layer defining the at least one interface region that includes the first material, a second polymer, and a second plurality of carbon fibers.

In certain aspects, the at least one interface region is disposed along a surface of the first component.

In certain aspects, the first material is selected from the group consisting of: titanium, copper, zinc, nickel, aluminum, alloys, mild steel, and combinations thereof. Further, the second material is selected from the group consisting of: steel, stainless steel, aluminum, magnesium, alloys, and combinations thereof.

In certain aspects, the assembly is selected from the group consisting of: a hood, an underbody shield, a structural panel, a door panel, a lift gate panel, a tailgate, a floor, a floor pan, a roof, a deck lid, an exterior surface, a fender, a scoop, a spoiler, a gas tank protection shield, a trunk, a truck bed, and combinations thereof.

In certain aspects, the first component further includes a patch defining the at least one interface region on a surface of the first component. The patch includes the first material, a second polymer, and a second plurality of carbon fibers.

In certain aspects, the first component further includes at least one third material having a third electrochemical potential that is distinct from the first electrochemical potential of the first material and the second electrochemical potential of the second material. The first material and the third material are disposed in contact with one another and form a multilayer coating.

In certain aspects, the at least one interface region extends from greater than or equal to about 5 mm to less than or equal to about 25 mm from a terminal edge of the first component that is in contact with the second component.

The present disclosure relates to an assembly for a vehicle having reduced galvanic corrosion. The assembly includes a first component defining at least one interface region that includes a polymeric composite including a polymer and a plurality of carbon fibers coated with a first material selected from the group consisting of: titanium, copper, zinc, nickel, aluminum, alloys, mild steel, and combinations thereof. The coating has a thickness of greater than or equal to about 100 nm to less than or equal to about 10 micrometers. The assembly also includes a second component including a second material in contact with the at least one interface region. The material is selected from the group consisting of: steel, stainless steel, aluminum, magnesium, alloys, and combinations thereof. In the presence of an electrolyte, the first material is more noble than the second material.

In certain aspects, the second component is a fastener or hinge and the at least one interface region extends from greater than or equal to about 5 mm to less than or equal to about 25 mm from a terminal edge of the first component that is in contact with the second component.

The present disclosure further relates to a method of reducing galvanic corrosion in an assembly for a vehicle. The method includes introducing a first material having a first electrochemical potential to at least one interface region of a first component including a first polymer and a first plurality of carbon fibers. The first component is configured to be assembled with and to contact a second component including a second material adjacent to the at least one interface region to define the assembly. The second material has a second electrochemical potential less than the first electrochemical potential, so that in the presence of an electrolyte, the first material is more noble than the second material.

In certain aspects, the introducing includes forming a layer in the first component that defines the at least one interface region, wherein the layer includes the first material, a second polymer, and a second plurality of carbon fibers.

In certain aspects, the introducing includes coating at least a portion of the plurality of carbon fibers with the first material. The plurality of carbon fibers having the coating are disposed in the at least one interface region of the first component.

In certain aspects, the introducing includes applying a patch including the first material onto a surface of the first component in the at least one interface region, wherein the patch further includes a second polymer and a second plurality of carbon fibers.

In certain aspects, the first material is disposed as a coating on the second plurality of carbon fibers.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows an exemplary schematic of galvanic corrosion mechanism at a junction between two dissimilar materials, including a carbon-fiber reinforced composite in the presence of an electrolyte;

FIG. 2 shows an exemplary schematic of an assembly of dissimilar materials for a vehicle having a carbon fiber reinforced composite with at least one galvanically protective first material disposed thereon at an interface region near a junction with a dissimilar material to provide corrosion protection in accordance with certain aspects of the present disclosure;

FIG. 3 shows a side sectional view of a carbon fiber having a coating of a galvanically protective material in accordance with certain aspects of the present disclosure;

FIG. 4 shows a cross-sectional view taken along line 4-4 in FIG. 3 of the carbon fiber having the coating of a galvanically protective material in accordance with certain aspects of the present disclosure;

FIG. 5 shows a process to form a carbon fiber reinforced composite for an assembly having reduced galvanic corrosion by way of a protective polymeric composite surface layer via a simplified resin transfer molding (RTV) process according to certain aspects of the present disclosure; and

FIG. 6 shows a process to form a carbon fiber reinforced composite for an assembly having reduced galvanic corrosion by way of inclusion of a protective polymeric composite patch via a simplified resin transfer molding (RTV) process according to certain aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

Vehicle bodies may have assemblies of complementary structural components, like panels or members, attached or fastened to one another or having a panel attached or fastened to a frame structure. Vehicle doors and other closure members are often made of an assembly of inner and outer components or panels. The panels of the assembly can be made of similar materials, for example, stamped steel or aluminum sheets, which are then joined by welding, hemming, mechanical fasteners, or adhesive bonding. However, such stamped metal sheets may be heavy. In a continuing effort to improve fuel efficiency and reduce weight of a range of automotive vehicles used worldwide, it is advantageous to form components of durable, lighter materials, such as reinforced composite materials like carbon-reinforced plastics or other composite materials. For example, inner and outer door panels, lift gate panels or tailgates, hoods and deck lids, and the like can be made of any combination of steel panels, aluminum panels, magnesium panels, carbon fiber composite panels to satisfy structural, weight, and appearance requirements. Such dissimilar material assemblies may also be used to create structural subsystems or body frames that comprise panels and structural members of various shapes, including castings and extrusions, and the like.

However, as discussed above, use of dissimilar materials in component assemblies has often been avoided or limited due to issues with galvanic corrosion, especially when considering use of carbon-fiber composite materials with metals, such as ferrous alloys, like steel, stainless steel, aluminum alloys or magnesium alloys.

A carbon-containing composite material is a composite comprising a polymeric matrix and particles comprising carbon (dispersed in the polymeric matrix for reinforcement), which can be a plurality of fibers. Carbon fibers are used as a lightweight reinforcement phase to make high-strength lightweight polymeric composite materials. Carbon fibers can be produced by carbonizing or graphitizing carbon fiber precursor material fibers. Carbon fiber precursors may be formed from polyacrylonitrile (PAN), petroleum pitch, or rayon precursors, by way of example. Carbon fibers and graphite fibers are made and heat-treated at different temperatures and thus each has different carbon content. Typically, a carbon fiber is considered to be a fiber that has at least about 90% by weight carbon. Suitable carbon fibers also include graphite fibers, graphene fibers, carbon nanotubes, and the like, by way of non-limiting example.

Suitable carbon fiber-reinforced composite materials comprise a polymer reinforced with a carbon fiber material. The polymer may be a thermoplastic resin or a thermoset resin. Suitable polymeric matrices include polyester, epoxy, vinyl ester, phenolic resins, bismaleimides, polyimides, vinyl chloride resin, vinylidene chloride resin, vinyl acetate resin, polyvinyl alcohol resin, polystyrene resin, acrylonitrile styrene resin, acrylonitrile-butadiene-styrene resin, acrylic resin, methacrylate resin, polyethylene resin, polypropylene resin, polyamide resin (PA6, PA11, PA12, PA46, PA66, PA610), polyacetal resin, polycarbonate resin, polyethylene terephthalate resin, polyethylene naphthalate resin, polybutylene terephthalate resin, polyacrylate resin, polyphenylene ether resin, polyphenylene sulfide resin, polysulfone resin, polyether sulfone resin, polyether ether ketone resin, polylactide resin, polyhydroxyether resin, polyphenylenoxide resin, styrene/maleic anhydride (SMA) resin, isoprene/SMA resin, 1,2-polybutadiene resin, silicone resin (e.g., SYLGARD™ 186), or any combination or copolymer of these resins. In certain variations, the polymer matrix may comprise a polymer or a polymer precursor selected from the group consisting of: an epoxy resin, such as a bisphenol A epoxy resin, a bisphenol A based polyester resin, a polyurethane, a urethane modified epoxy resin, a novolac-based epoxy resin, an acrylate resin, a polyvinyl chloride (PVC)-based resins, butyl rubber, and/or a vinyl ester resin, and combinations thereof, by way of non-limiting example. In certain aspects, a particularly suitable thermoset polymer matrix comprises epoxy or polyurethane. In certain aspects, a particularly suitable thermoplastic polymer matrix comprises polyamide or polycaprolactam.

The carbon fibers may be continuous filaments or may be chopped carbon fibers that may be thousands of micrometers (m) or millimeters (mm) in length. A group of continuous carbon fibers is often categorized as a bundle of continuous carbon fiber filaments. Carbon fiber “tow” is usually designated as a number of filaments in thousands (designated by K after the respective tow number). Alternatively, carbon fiber bundles may be chopped or milled and thus form short segments of carbon fibers (filaments or bundles) typically having a mean fiber length. The carbon fibers may be provided as fiber mats having interconnecting or contacting fibers or may be randomly distributed individual fibers within the resin matrix. The carbon fibers within the composite may be configured to have a random orientation or a directional (e.g., anisotropic) orientation. In certain variations, a fiber mat comprising carbon fibers may be used with highly planar oriented or uni-directional oriented fibers or combinations thereof. The fiber mat may have a randomly oriented fiber. In certain variations, a random carbon fiber mat can be used as a preform of a fiber-reinforced composite material that is shaped. Alternatively, the carbon fibers may be woven into a fabric. After introducing the polymeric matrix to the carbon fibers, the carbon-fiber reinforced composite material exhibits suitable mechanical properties, such as strength, stiffness, and toughness.

A carbon fiber reinforced composite may comprise greater than or equal to about 10% by weight to less than or equal to about 75% by weight of carbon fibers, with a balance being the polymeric matrix. In certain variations, the carbon fiber reinforced composite optionally comprises greater than or equal to about 25% by weight to less than or equal to about 70% by weight, optionally greater than or equal to about 45% by weight to less than or equal to about 65% by weight, and in certain variations, optionally greater than or equal to about 45% by weight to less than or equal to 60% by weight of carbon fibers.

By way of non-limiting example, a carbon-fiber composite may have an ultimate tensile strength of greater than or equal to about 200 MPa to less than or equal to about 2,000 MPa, where greater strengths are provided by continuous carbon fiber filaments as compared to chopped carbon fibers.

Composite articles or components can be formed by using sheets or strips of a reinforcement material, such as a carbon fiber-based material having continuous carbon fibers. Polymer precursors, such as resins, can be impregnated in carbon fiber-based substrate material systems, known as pre-impregnating (referred to as “pre-preg”) that involves wetting an uncured or partially cured resin into the carbon fiber-based substrate material in a first step, then optionally winding up the carbon fiber-based substrate material, and storing it for later use. Thus, carbon-fiber reinforced polymeric composites (CFRP) include a resin that is cured and/or solidified to form a polymeric matrix having a plurality of carbon fibers distributed therein as a reinforcement phase.

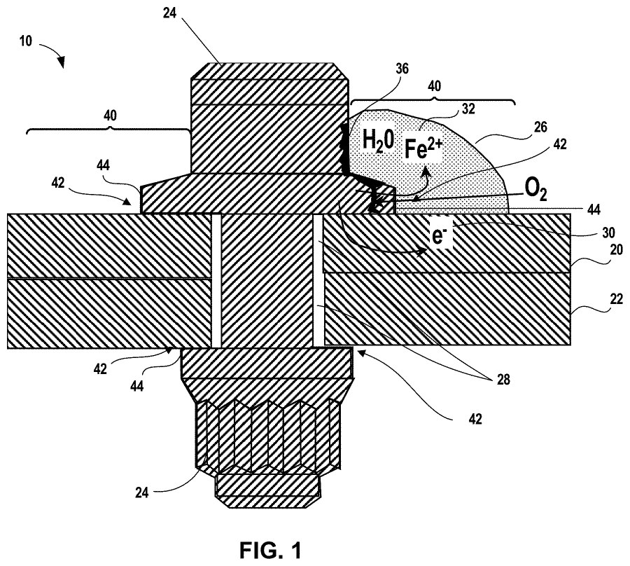

In accordance with various aspects of the present disclosure, methods for preventing galvanic corrosion in assemblies comprising dissimilar materials are provided. By way of background, FIG. 1 shows a typical mechanism for galvanic corrosion mechanism between two dissimilar materials used in an assembly 10 (e.g., for an automotive component). The assembly 10 includes a first carbon-fiber reinforced composite (CFRP) panel 20 and a second carbon-fiber reinforced composite (CFRP) panel 22. Each of the carbon fiber reinforced composite materials forming the first CFRP panel 20 or the second CFRP panel 22 may comprise a polymeric matrix and a plurality of carbon fibers as a reinforcement phase. It should be noted that the second CFRP panel 22 need not be a carbon fiber reinforced composite, but may be formed of a different material, such as a metal. The first CFRP panel 20 and second CFRP panel 22 may be mechanically fastened together by a mechanical fastener 24 (e.g., a nut and bolt (as shown), rivet, screw, and the like) that is formed of a dissimilar material, such as a metal. In certain variations, the metal forming the fastener 24 may comprise a metal selected from the group consisting of: iron (e.g., steel, stainless steel), aluminum, magnesium, alloys and combinations thereof. As shown in FIG. 1, the fastener 24 is a nut and bolt that is formed of a steel comprising iron. The fastener 24 passes through aligned apertures 28 defined in each of the first CFRP panel 20 and the second CFRP panel 22.

In applications like automotive vehicles, exposure to electrolytes like water may be localized and intermittent. As shown in FIG. 1, a droplet of electrolyte 26 (e.g., water) is present on the first CFRP panel 20 adjacent to the fastener 24. The presence of the electrolyte 26 makes it possible for an ionically conductive path to be established between the first CFRP panel 20 and the second CFRP panel 22, thus forming a closed circuit. In these cases the electrical path is provided by the fastener 24 itself in contact with the carbon fiber in the first CFRP panel 20, while the electrolyte 26 provides ionic conduction. In doing so, due to the differences in galvanic potential between the first CFRP panel 20 and the steel fastener 24 or between the second CFRP panel 22 and the steel fastener 24, the carbon containing composite material of either the first CFRP panel 20 or second CFRP panel 22 facilitates generation of electrons 30 and metal cations 32 (e.g., Fe²⁺) 32 by oxidative disassociation of the anodic metal material or material having a lower electrochemical potential. In the material couple of carbon fiber reinforced polymeric composite and steel fastener, the material with lower electrochemical potential is steel which is more anodic and less noble. The metal material in steel fastener 24 has a relatively low standard electrode potential of approximately −0.6 V versus Standard Calomel Electrode (SCE) (V⁰) on the galvanic or electromotive force (emf) series as compared to the carbon containing composite material (+0.27 V versus SCE) in either the first CFRP panel 20 or the second CFRP panel 22. Thus, the first or second carbon containing composite material (CFRP) panels 20, 22 serve as a cathode in such a galvanic couple (having positive cations), while the steel fastener 24 serves as an anode that generates electrons and metal cations 32 and is sacrificed during the corrosion process, as shown by corrosion pitting 36. Where the fastener is steel and the panels 20, 22 are CFRP, a driving force or difference between the electrochemical potentials of respective materials is about 0.87 V.

Notably, FIG. 1 shows interface regions 42 (e.g., a surface or boundary of the first CFRP panel 20 or second CFRP panel 22 that contact or are adjacent to the fastener 24 formed of a dissimilar material) where the carbon containing composite material panel 22 is near or contacts the fastener 24 and may be exposed to electrolyte 26 (H₂O) and thus where corrosion typically occurs. Notably, the interface regions 42 only occur where the fastener 24 ends in proximity or contact with the first CFRP panel 20 or the second CFRP panel 22 and there might be potential electrolyte 26 exposure, but is not associated with every contact region defined between the fastener 24 and either of the first CFRP panel 20 or the second CFRP panel 22.

Generally, a corrosion susceptible region or zone 40 between the fastener 24 and the first CFRP panel 20 and/or the second CFRP panel 22 is understood to be adjacent to or near the interface regions 42 between the first CFRP panel 20 or the second CFRP panel 22 and the fastener 24, which may come into contact with the electrolyte 26 to establish electrical and ionic communication and close an electrical circuit between the dissimilar materials (the carbon-reinforced composite material (CFRP) panels 20, 22 and the metal fastener 24). Depending on the geometry of the respective materials that are in proximity to one another, such a corrosion susceptible region 40 is typically less than or equal to about 25 mm from a terminal edge 44 of the fastener 24 in contact with the first CFRP panel 20 or the second CFRP panel 22.

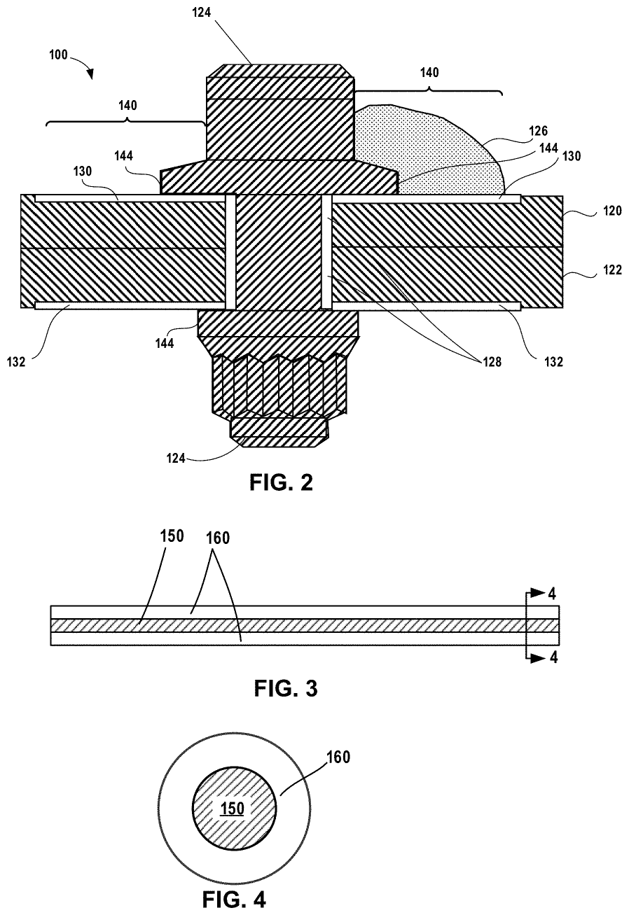

FIG. 2 shows an assembly 100 for an automotive component having two components comprising distinct materials, but having reduced galvanic corrosion. While the assemblies provided by the present technology are particularly suitable for use in components of an automobile or other vehicles (e.g., motorcycles, boats, tractors, buses, motorcycles, mobile homes, campers, and tanks), they may also be used in a variety of other industries and applications, including aerospace components, consumer goods, devices, buildings (e.g., houses, offices, sheds, warehouses), office equipment and furniture, and industrial equipment machinery, agricultural or farm equipment, or heavy machinery, by way of non-limiting example. In certain aspects, the assembly for an automotive component may be selected from the group consisting of: a hood, an underbody shield, a structural panel, a door panel, a lift gate panel, tailgate, a floor, a floor pan, a roof, a deck lid, an exterior surface, a fender, a scoop, a spoiler, a gas tank protection shield, a trunk, a truck bed, and combinations thereof, by way of non-limiting example.

The assembly 100 includes at least one carbon-containing polymeric composite. As shown in FIG. 2, the assembly 100 includes a first carbon-fiber reinforced composite (CFRP) panel 120 and a second carbon-fiber reinforced composite (CFRP) panel 122. Each of the carbon fiber reinforced composite materials forming the first CFRP panel 120 or the second CFRP panel 122 may comprise a polymeric matrix and a plurality of carbon fibers as a reinforcement phase. It should be noted that the second CFRP panel 122 is merely optional and shown for purposes of illustration and further, if present, need not be a carbon fiber reinforced composite, but may be formed of a different material, such as a metal. However, at least one component in the assembly 100 is formed from a carbon-containing polymeric composite. The carbon fiber reinforced polymer composite forming the first CFRP panel 120 and second CFRP panel 122 has a first electrochemical potential, which can generally be approximated by the electrochemical potential for graphite. Further, other assembly designs and configurations are contemplated, as the design shown in FIG. 2 is merely illustrative of certain principles of the present teachings.

The first CFRP panel 120 and second CFRP panel 122 may be in contact with a second distinct material having a second electrochemical potential. As shown in FIG. 2, the component with the distinct second material is a mechanical fastener 124 (e.g., a nut and bolt rivet, screw, and the like) that is formed of a metal. In certain variations, the metal forming the fastener 124 may comprise a metal selected from the group consisting of: iron (e.g., an iron alloy like steel or stainless steel), aluminum, magnesium, alloys and combinations thereof. As shown in FIG. 2, the fastener 124 is a nut and bolt that is formed of a steel alloy comprising iron. The fastener 124 passes through aligned apertures 128 defined in each of the first CFRP panel 120 and the second CFRP panel 122.

A droplet of electrolyte 126 (e.g., water) is shown on the first CFRP panel 120 adjacent to the fastener 124. As discussed above, the presence of the electrolyte 126 makes it possible for an electrically and ionically conductive path to be established between the first CFRP panel 120 and fastener 124 (or between the second CFRP panel 122 and the fastener 124), thus forming a closed electrical and ionic circuit. To protect the fastener 124 having the second lower electrochemical potential as compared to the first electrochemical potential of the first CFRP panel 120 from galvanic corrosion, a first plurality of interface regions 130 are defined on an exposed surface of the first CFRP panel 120. The plurality of interface regions 130 correspond to a surface or boundary of the first CFRP panel 120 that is near or in contact with the adjacent fastener 124 formed of a dissimilar material. The first plurality of interface regions 130 include regions not only in proximity to the fastener 124, but also regions where the first CFRP panel 120 may be exposed to electrolyte 126 and thus where corrosion typically occurs. Notably, the first plurality of interface regions 130 only occur where the fastener 124 ends in proximity or contact with the first CFRP panel 120 and there might be potential electrolyte exposure, but is not associated with every contact region defined between the fastener 124 and the first CFRP panel 120. Likewise, a second plurality of interface regions 132 are defined on an exposed surface of the second CFRP panel 122.

The first plurality of interface regions 130 and the second plurality of interface regions 132 extend beyond a corrosion susceptible region or zone 140 defined between the fastener 124 and the first CFRP panel 120 and/or the second CFRP panel 122. Depending on the geometry of the respective materials that are in proximity to one another, such a corrosion susceptible region 140 is typically less than or equal to about 25 mm from a terminal edge 144 of the fastener 124. In certain variations, the first plurality of interface regions 130 and the second plurality of interface regions 132 may respectively extend at least greater than or equal to about 5 mm to less than or equal to about 25 mm, and in certain aspects, optionally greater than or equal to about 7 mm to less than or equal to about 10 mm from the terminal edge 144 of the fastener 124 in contact with the first CFRP panel 120 or the second CFRP panel 122. As shown, the first plurality of interface regions 130 and the second plurality of interface regions 132 have a length on the first CFRP panel 120 and/or second CFRP panel 122 that extends beneath the terminal edge 144 of the fastener 124. Thus, in certain variations, each of the first plurality of interface regions 130 and the second plurality of interface regions 132 may have a total length of greater than or equal to about 5 mm to less than or equal to about 25 mm and may have a depth or thickness of greater than or equal to about 100 nm to less than or equal to about 25 micrometers.

As will be described in further detail below, the first plurality of interface regions 130 and the second plurality of interface regions 132 comprise a material that serves to reduce galvanic corrosion in the system. In certain variations, the material in the first and second first plurality of interface regions 130, 132 may be selected to have an electrochemical potential that is more noble than the electrochemical potential of the second material forming the second component (here, the steel metal forming the fastener 124) to minimize a driving force behind the galvanic corrosion reaction. In other alternative variations, the material in the first and second first plurality of interface regions 130, 132 may be selected to have an electrochemical potential that is less noble than the electrochemical potential of the second material forming the second component (here, the steel metal forming the fastener 124) and thus serve as a sacrificial material.

A list of standard electrochemical potentials for select materials versus Standard Calomel Electrode (SCE) (V⁰) on the galvanic or electromotive force (emf) series are set forth in Table 1.

TABLE 1

| MATERIAL | VOLTAGE RANGE |
|---|---|
| Magnesium | −1.30 to −1.67 |
| Zinc | −1.00 to −1.07 |
| Aluminum Alloys | −0.76 to −0.99 |
| Mild Steel | −0.58 to −0.71 |
| Cast Iron | −0.58 to −0.71 |
| Low Alloy Steel | −0.56 to −0.64 |
| Austenitic Cast Iron | −0.41 to −0.54 |
| Copper | −0.31 to −0.40 |
| Stainless Steel (410, 416) | −0.24 to −0.37 |
| | (−0.45 to −0.57) |
| 90/10 Copper/Nickel | −0.19 to −0.27 |
| 80/20 Copper/Nickel | −0.19 to −0.24 |
| Stainless Steel (430) | −0.20 to −0.30 |
| | (−0.45 to −0.57) |
| 70/30 Copper/Nickel | −0.14 to −0.25 |
| Nickel 200 | −0.09 to −0.20 |
| Stainless Steel (302, 304, 321, 347) | −0.05 to −0.13 |
| | (−0.45 to −0.57) |
| Nickel Copper Alloys (400, K500) | −0.02 to −0.13 |
| Stainless Steel (316, 317) | 0.00 to −0.10 |
| | (−0.35 to −0.45) |
| Alloy 20 Stainless Steel | 0.04 to −0.12 |
| Titanium | 0.04 to −0.12 |
| Graphite | 0.36 to 0.19 |

Where the fastener 124 is steel and the panels 120, 122 are CFRP, but the interface regions 130, 132 comprise a galvanically protective material, like copper, having an electrochemical potential higher from that of the second electrochemical potential of the fastener 124, a driving force or difference between the electrochemical potentials of respective materials may be reduced or diminished by the presence of the galvanically protective metal in the interface regions, as compared to that of the comparative assembly lacking any interface regions. This is a counterintuitive approach in not selecting a material that has an electrochemical potential that is less than that of the second electrochemical potential of the fastener 124, but rather to select a material that has a higher electrochemical potential than the material being protected and to minimize a driving force rather than serve as a sacrificial electrode. In certain aspects, the galvanically protective material is selected from the group consisting of: titanium, copper, zinc, nickel, aluminum, alloys, and combinations thereof. By way of example, where the second distinct material comprises stainless steel in the assembly comprising a carbon fiber reinforced polymeric composite component, the galvanically protective material may be titanium. Alternatively, where the second distinct material comprises a ferrous alloy, like steel, the galvanically protective material may be copper. Further, where the second distinct material comprises aluminum, the galvanically protective material may comprise a mild steel material.

As an illustration, a driving force or difference between the electrochemical potentials of respective materials is about 0.25 V, where the fastener 124 is steel and the panels 20, 22 are CFRP, but the interface regions 130, 132 comprise copper. This driving force is significantly reduced as compared to a driving force or difference between the electrochemical potentials of respective materials in a comparative assembly lacking any interface regions as in FIG. 1, where the driving force was about 0.87 V.

In certain variations, the first component not only comprises a galvanically protective first material, but also further comprises one or more additional galvanically protective materials, such as at least one third material having a third electrochemical potential different than the first electrochemical potential of the first material and the second electrochemical potential of the second material. In certain variations, the third electrochemical potential of the third material is less noble or lower than the first electrochemical potential of the first material and more noble than the second electrochemical potential of the second material, such that the third material lies between the first and second materials on the galvanic scale. The first material and the third material are disposed in contact with one another and form a multilayer coating. In one variation, the galvanically protective first material may comprise nickel disposed on the carbon fiber and the galvanically protective second material may comprise copper disposed over the nickel.

In one variation, like that shown in FIGS. 3 and 4, an exemplary continuous carbon fiber having a galvanically protective material coating disposed thereon prepared in accordance with certain aspects of the present disclosure is shown. In FIGS. 3 and 4, a continuous carbon fiber 150 is disposed in a core region that is surrounded by a sheath region comprising a coating 160. The coating 160 comprises the galvanically protective material or materials like those discussed above having an electrochemical potential below that of the second distinct material in the second component. The coating 160 may have a thickness of greater than or equal to about 500 nm to less than or equal to about 5 micrometers, optionally greater than or equal to about 1 micrometer (μm) to less than or equal to about 4.5 μm, and in certain variations, optionally greater than or equal to about 2 μm to less than or equal to about 4 μm.

The carbon fibers having a galvanically protective material coating may be incorporated into the polymeric matrix. In certain variations, all of the carbon fibers in the polymeric composite may be coated with a galvanically protective material. In other aspects, only a portion of the carbon fibers used as a reinforcement phase may comprise the carbon fibers coated with the galvanically protective material. In certain variations, the carbon fibers may be selectively woven into the polymeric composite component in select regions that will define the one or more interface regions, so that a local concentration of the coated carbon fibers is high in the one or more interface regions, but regions outside the one or more interface regions may have conventional carbon fibers. It should be noted that carbon fibers in the interface regions of the carbon-fiber reinforced composite may have different coatings. For example, one portion of the carbon fibers may have a coating of a first material, while another portion of the carbon fibers may have a coating of a second material. In this manner, different metals providing galvanic protection can be incorporated into the composite.

In the interface regions, greater than or equal to about 95% up to about 100% by weight of the carbon fibers present are coated with the galvanically protective material coating, optionally greater than or equal to about 97% to greater up to about 100% by weight, optionally greater than or equal to about 98% up to about 100% by weight, and in certain variations, optionally greater than or equal to about 99% up to about 100% by weight of the carbon fibers present in the interface regions are coated with the galvanically protective material. However, in certain aspects, greater than or equal to about 1% to less than or equal to about 50% of an overall area of a surface of the component comprises the coated carbon fibers, optionally greater than or equal to about 5% to less than or equal to about 40% of the surface area, in certain variations, greater than or equal to about 10% to less than or equal to about 30%, and in still further variations, greater than or equal to about 15% to less than or equal to about 25% of the surface area comprises the carbon fibers having the galvanically protective material.

In certain aspects, a layer of a polymeric composite may be formed that comprises a plurality of carbon fibers having a coating of galvanically protective material distributed in a polymeric matrix. The layer may be disposed along one or more surfaces of the carbon fiber reinforced polymeric composite component to define a surface layer that can define one or more interface regions with a second component formed of a second distinct material.

In yet other aspects, a polymeric composite patch having predetermined dimensions may be formed that comprises a plurality of carbon fibers having a coating of galvanically protective material distributed in a polymeric matrix. The patch having the galvanically protected carbon fibers may then be disposed in a select region of the polymeric composite to form the one or more interface regions.

In various aspects, the present disclosure provides methods for mitigating galvanic corrosion in an assembly that comprises dissimilar materials, which include a carbon-containing polymeric composite material. In certain variations, such dissimilar materials may be a carbon-reinforced composite material and a metal material, such as a metal structural member for a vehicle, e.g., a panel. As noted above, the methods of mitigating galvanic corrosion and components formed therefrom are not limited to vehicle components, like panels for vehicles, but may be any type of assembled components for vehicles. Further, in certain variations, the present teachings may apply more broadly to any use of dissimilar materials in a component assembly and are not limited to only vehicle or automotive applications.

Accordingly, in certain aspects, the present disclosure contemplates minimizing or preventing galvanic corrosion in an assembly of dissimilar materials, such as a carbon fiber reinforced composite material and a metal material in near proximity or contact with one another. It should be noted that “minimizing” or “mitigating” are intended to mean that over longer durations of time, some minor corrosion may occur with use of such dissimilar materials, but it amounts to relatively minor corrosion damage that will not impede functioning or otherwise cause mechanical failure of the parts. However, in certain variations, the methods of the present disclosure serve to prevent galvanic corrosion altogether for a service life of a vehicle when such dissimilar materials are used in proximity to one another. A service life of a vehicle may be greater than or equal to about 5 years, optionally greater than or equal to about 7 years, optionally greater than or equal to about 8 years, optionally greater than or equal to about 9 years, optionally greater than or equal to about 10 years, and in certain variations, greater than or equal to about 15 years.

Thus, in certain aspects, the present disclosure provides a method of minimizing or preventing galvanic corrosion in an assembly for a vehicle, which optionally comprises introducing a first material having a first electrochemical potential to at least one interface region of a first component comprising a first polymer and a first plurality of carbon fibers. The first component is configured to be assembled with and to contact a second component comprising a second material adjacent to the at least one interface region to define the assembly. The second material has a second electrochemical potential different than the first electrochemical potential. In certain variations, the first material may have an electrochemical potential that is more noble than the second electrochemical potential of the second material to minimize a driving force behind the galvanic corrosion reaction. In other alternative variations, the first material may have an electrochemical potential that is less noble than the second electrochemical potential of the second material to serve as a sacrificial material. In certain variations, the method may comprise assembling the first component with the second component so that at least a portion of the each of the first component and the second component are in contact with or near proximity with one another. The methods of the present disclosure fasten or couple a carbon fiber reinforced composite vehicle component to a second metal vehicle component to form an assembly. The first and second material may be any of those described previously above.

In certain variations, the introducing comprises forming a layer in the first component that defines the at least one interface region. The layer comprises the galvanically protective first material, a second polymer, and a second plurality of carbon fibers. In certain variations, such a layer may be formed by contacting a fabric or mat formed of a plurality of carbon fibers with a plating medium.

For example, in the case of copper, the plating medium or bath may comprise copper (II) hydrosulfate (Cu(HSO₄)₂) and hydrochloric acid in water, which may be adjusted to have a pH of about 2.5. In certain variations, the plating medium may have a temperature of about 75° C.

For nickel, the plating medium or bath may comprise nickel sulphamate and nickel chloride mixed with boric acid, which may be adjusted to have a PH value of about 3.5-4.5 at an elevated temperature of 40-60° C., by way of example.

For zinc, zinc chloride or zinc sulfate mixed with ammonium chloride and potassium chloride can be used for plating medium, which may be adjusted to have a PH value of 5.5-6.0. In certain variations, the plating medium may have a temperature of about 60° C., by way of example. In certain variations, the plating medium may be at room temperature.

Further in the case of titanium, the plating medium or bath may optionally comprise Ti(OH)₂, HCl and NH₄Cl in water, which may be adjusted to have a pH of about 4-5. In certain variations, the plating medium may have a temperature of about 50° C.

Aluminum can be plated from ionic liquid electrolyte at a room temperature, such as in the process described in Koura, et al., “Electroless Plating of Aluminum from a Room-Temperature Ionic Liquid Electrolyte,” J. Electochem. Soc., 155(2) D155-D157 (2008), the relevant portions of which are incorporated herein by reference.

Thus, a layer of carbon fibers may be contacted with or passed through the plating medium bath to form the layer having at least the surfaces and optionally the body of the layer coated with the galvanically protective first material. Other methods of selectively applying metals to a surface of a layer are also contemplated, including vacuum deposition or vapor deposition of metals, by way of non-limiting example.

In other variations, the introducing may include coating a plurality of carbon fibers with the first material that is galvanically protective. Then at least a portion or optionally all of the plurality of carbon fibers in the composite material may include the plurality of carbon fibers having the coating of the first material. The plurality of carbon fibers having the coating of the galvanically protective first material are disposed in the at least one interface region of the first component. In certain aspects, the plurality of carbon fibers may be coated by contacting carbon fiber filaments with a bath comprising a plating medium or bath, such as those described above. Thus, the carbon fiber may be passed through a plating medium bath to form the coating comprising the galvanically protective first material on the carbon fiber. Other metal deposition techniques for coating carbon fibers may also be employed. The coated carbon fibers may then be formed into tows and/or assembled together (e.g., by weaving or felting) to form fabrics or mats to which a polymeric matrix is introduced, as is known to those of skill in the art.

In certain other aspects, the introducing comprises applying a patch onto a surface of the first component in the at least one interface region. In other words, the patch may define the at least one interface region on the first component. The patch may have a predetermined dimension based on the corrosion zone and configuration of the dissimilar materials to be joined. The at least one interface region extends from greater than or equal to about 5 mm to less than or equal to about 25 mm, or optionally from greater than or equal to about 7 mm to less than or equal to about 10 mm, from a terminal edge of the first component that is in contact with the second component. The patch comprises the first material and further comprises a second polymer and a second plurality of carbon fibers. In certain variations, the patch may comprise carbon fibers having a coating of the galvanically protective first material that are formed into a fabric or mat. The polymeric matrix may be disposed within the openings or pores in the fabric or mat. Of the carbon fibers present in the composite material defining the patch, greater than or equal to about 85% up to about 100% are the coated carbon fibers with the first material. In other aspects, a mat or fabric having the patch dimensions and comprising uncoated carbon fibers may be exposed to a plating medium, as discussed above, where surfaces and optionally the interior body region is coated with the galvanically protective first material. Other methods of selectively applying metals to a surface of a patch are also contemplated, including vacuum deposition or vapor deposition of metals, by way of non-limiting example. Then, a polymeric matrix may be formed around the coated carbon fiber fabric or mat.

Any suitable molding technique may be employed for forming components of the carbon-fiber reinforced polymer composite, including the at least one interface region having the first material, for example, resin transfer molding, liquid laydown molding, compression molding, sheet molding, thermoforming, injection overmolding, injection compression overmolding, and the like. Generally, molding of the component includes placing one or more preformed carbon fiber structures, such as layers of dry carbon-fiber fabrics or mats, into a mold. A polymer or polymer precursor can then be introduced (e.g., injected) under pressure to fill in the voids and pores within the preformed carbon fiber structures. Then, elevated temperatures, elevated pressures or both may be applied within the mold so that the material inside assumes the shape of the mold.

In certain variations, following coating of the first material on the carbon fibers (when coated individually), the carbon fibers may be dispersed in a precursor of a polymer matrix to form a mixture. The mixture formed may then be cured or solidified. Injection molding techniques known in the art may also be used to introduce a resin into the carbon fiber reinforcement material, particularly where the carbon fiber reinforcement material are discontinuous fibers. For example, a precursor comprising a resin and the reinforcement material may be injected or infused into a defined space or mold followed by solidification of the precursor to form the polymeric composite material. The term “injection molding” also includes reaction injection molding using a precursor of a thermoset resin.

Compression molding, which may include sheet molding, may comprise introducing a pre-blend of components disposed on a lower die, then moving one or both dies towards the other to form a closed cavity. The dies may possess embossing structures and texture designed to transfer embossments and grain to the molded article, such as a door, as is known in the art. During pressing, the components are pressed together between the upper and lower dies and shaped by application of heat and pressure. For the case of thermoforming, the plated carbon fiber fabric is wetted with molten thermoplastic polymer and solidified into an organosheet. This material can be heated above the melting point of the polymer and then placed into the cold die. By either pulling vacuum or applying pressure to draw the sheet over to the cold cavity. The sheet is then shaped to the final part geometry.

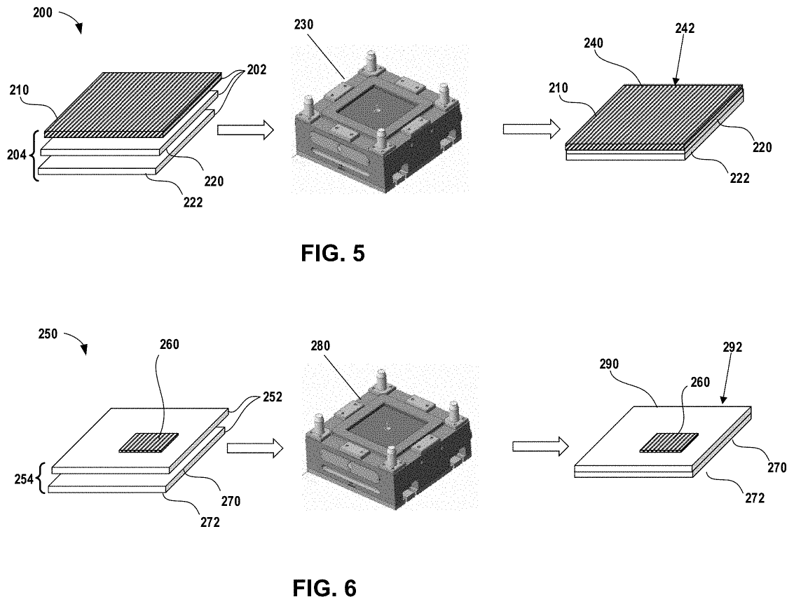

One further non-limiting example of a process to form a carbon fiber reinforced composite for an assembly having reduced galvanic corrosion is a simplified resin transfer molding (RTM) process 200 shown in FIG. 5. A plurality of sheets 202 of carbon fiber material may be stacked together to define a stack 204 and optionally may have different orientations within the stack 204. A first sheet 210 includes the galvanically protective first material and a first plurality of carbon fibers (whether as a coating formed over a portion of the individual carbon fibers or as a coating formed on a mat or fabric of the preassembled carbon fibers, as described above). A second sheet 220 comprises a second plurality of carbon fibers and a third sheet 222 comprises a third plurality of carbon fibers. Notably, the second and third pluralities of carbon fibers lack the first material. Further, as will be appreciated by those of skill in the art, the sheets 202 in the stack 204 are not limited to the shapes shown or only three sheets, but may in fact have different shapes or a different number of sheets.

The stack 204 of sheets 202 is then disposed within a mold (not shown) of a resin transfer molding device 230. For resin transfer molding, dry fiber reinforcement materials are placed into a mold and then resin (e.g., a polymer precursor) may be infused into the mold under pressure (e.g., about 10 psi to about 2,000 psi). After compression and infusion of the polymeric matrix into the carbon fiber in the sheets 202, a consolidated component 240 is formed that includes the first sheet 210 having the first material, along with the second and third sheets 220, 222. The first sheet 210 defines an outer layer of the consolidated component 240 on an exposed surface 242. While not shown, after RTM or other types of molding, one or more apertures, openings, interlocks, indentations, and the like may optionally be formed in the consolidated component 240 that can receive a part, like a fastener, or otherwise establish contact with another second dissimilar material. The areas that will contact a dissimilar material along the exposed surface 242 will define the one or more interface regions. As will be appreciated by those of skill in the art, while not shown, other exposed surfaces of the consolidated component 240 may also comprise a carbon-fiber reinforced sheet that includes a first material.

FIG. 6 shows another non-limiting RTV process 250 to form a carbon fiber reinforced composite for an assembly having reduced galvanic corrosion. A plurality of sheets 252 of carbon fiber material may be stacked together to define a stack 254 and optionally may have different orientations within the stack 254. A patch 260 includes the galvanically protective first material and a first plurality of carbon fibers (whether as a coating formed over a portion of the individual carbon fibers or as a coating formed on a mat or fabric of the preassembled carbon fibers, as described above). A second sheet 270 comprises a second plurality of carbon fibers and a third sheet 272 comprises a third plurality of carbon fibers. Notably, the second and third pluralities of carbon fibers lack the first material. Further, as will be appreciated by those of skill in the art, the sheets 252 in the stack 254 are not limited to the shapes shown or to only three sheets, but may in fact have different shapes or a different number of sheets.

The stack 254 of sheets 252 is then disposed within a mold (not shown) of a resin transfer molding device 280. Again, as described above, for resin transfer molding dry fiber reinforcement materials are placed into a mold and then resin (e.g., a polymer precursor) may be infused into the mold under pressure (e.g., about 10 psi to about 2,000 psi). After compression and infusion of the polymeric matrix into the carbon fiber in the sheets 202, a consolidated component 290 is formed that includes the patch 260 embedded into the second sheet 270. The consolidated component 290 also includes the third sheet 272. Together, the patch 260 and exposed regions of the second sheet 270 define an exposed surface 292 of the consolidated component 290. While not shown, after RTM or other types of molding, one or more apertures, openings, interlocks, indentations, and the like may optionally be formed in the patch region 260 of the consolidated component 290 that can receive a part, like a fastener, or otherwise establish contact with another second dissimilar material. The areas that will contact a dissimilar material along the exposed surface 292, for example, the patch 260, will define the one or more interface regions. As will be appreciated by those of skill in the art, while not shown, more than one patch 260 may be used on exposed surface 292 or other exposed surfaces of the consolidated component 290 may also comprise one or more patches.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An assembly for a vehicle having reduced galvanic corrosion, the assembly comprising:
a first component defining at least one interface region and comprising:
a polymeric composite comprising a polymer and a plurality of carbon fibers; and
a first material present in the at least one interface region and having a first electrochemical potential;
a second component comprising a second material in contact with the at least one interface region of the first component, wherein the second material has a second electrochemical potential different than the first electrochemical potential.

2. The assembly of claim 1, wherein the first electrochemical potential is higher than the second electrochemical potential, so that in the presence of an electrolyte the second material is less noble than the first material.

3. The assembly of claim 2, wherein:
(i) the first material comprises copper and the second material comprises steel;
(ii) the first material comprises titanium and the second material comprises stainless steel; or
(iii) the first material comprises mild steel and the second material comprises aluminum.

4. The assembly of claim 1, wherein the second electrochemical potential is higher than the first electrochemical potential, so that in the presence of an electrolyte the first material is less noble than the second material.

5. The assembly of claim 4, wherein:
(i) the first material comprises copper and the second material comprises stainless steel;
(ii) the first material comprises zinc and the second material comprises aluminum; or
(iii) the first material comprises aluminum and the second material comprises steel.

6. The assembly of claim 1, wherein each carbon fiber present in the interface region has a coating comprising the first material, wherein the coating has a thickness of greater than or equal to about 100 nm to less than or equal to about 10 micrometers.

7. The assembly of claim 1, wherein the polymeric composite comprises a layer defining the at least one interface region that comprises the first material, a second polymer, and a second plurality of carbon fibers.

8. The assembly of claim 1, wherein the at least one interface region is disposed along a surface of the first component.

9. The assembly of claim 1, wherein the first material is selected from the group consisting of: titanium, copper, zinc, nickel, aluminum, alloys, mild steel, and combinations thereof and the second material is selected from the group consisting of: steel, stainless steel, aluminum, magnesium, alloys, and combinations thereof.

10. The assembly of claim 1, wherein the assembly is selected from the group consisting of: a hood, an underbody shield, a structural panel, a door panel, a lift gate panel, a tailgate, a floor, a floor pan, a roof, a deck lid, an exterior surface, a fender, a scoop, a spoiler, a gas tank protection shield, a trunk, a truck bed, and combinations thereof.

11. The assembly of claim 1, wherein the first component further comprises a patch defining the at least one interface region on a surface of the first component, wherein the patch comprises the first material, a second polymer, and a second plurality of carbon fibers.

12. The assembly of claim 1, wherein the first component further comprises at least one third material having a third electrochemical potential that is distinct from the first electrochemical potential of the first material and the second electrochemical potential of the second material, wherein the first material and the third material are disposed in contact with one another and form a multilayer coating.

13. The assembly of claim 1, wherein the at least one interface region extends from greater than or equal to about 5 mm to less than or equal to about 25 mm from a terminal edge of the first component that is in contact with the second component.

14. An assembly for a vehicle having reduced galvanic corrosion, the assembly comprising:
a first component defining at least one interface region that comprises a polymeric composite comprising a polymer and a plurality of carbon fibers coated with a first material selected from the group consisting of: titanium, copper, zinc, nickel, aluminum, alloys, mild steel, and combinations thereof, wherein the coating has a thickness of greater than or equal to about 100 nm to less than or equal to about 10 micrometers; and
a second component comprising a second material in contact with the at least one interface region, wherein the second material is selected from the group consisting of: steel, stainless steel, aluminum, magnesium, alloys, and combinations thereof, so that in the presence of an electrolyte the first material is more noble than the second material.

15. The assembly of claim 14, wherein the second component is a fastener or hinge and the at least one interface region extends from greater than or equal to about 5 mm to less than or equal to about 25 mm from a terminal edge of the first component that is in contact with the second component.

16. A method of reducing galvanic corrosion in an assembly for a vehicle, the method comprising:
introducing a first material having a first electrochemical potential to at least one interface region of a first component comprising a first polymer and a first plurality of carbon fibers, wherein the first component is configured to be assembled with and to contact a second component comprising a second material adjacent to the at least one interface region to define the assembly, wherein the second material has a second electrochemical potential less than the first electrochemical potential, so that in the presence of an electrolyte, the first material is more noble than the second material.

17. The method of claim 16, wherein the introducing comprises forming a layer in the first component that defines the at least one interface region, wherein the layer comprises the first material, a second polymer, and a second plurality of carbon fibers.

18. The method of claim 16, wherein the introducing comprises coating at least a portion of the plurality of carbon fibers with the first material, wherein the plurality of carbon fibers having the coating are disposed in the at least one interface region of the first component.

19. The method of claim 16, wherein the introducing comprises applying a patch comprising the first material onto a surface of the first component in the at least one interface region, wherein the patch further comprises a second polymer and a second plurality of carbon fibers.

20. The method of claim 19, wherein the first material is disposed as a coating on the second plurality of carbon fibers.
